(19) United States
(12) Patent Application Publication
(10) Pub. No.: US 2023/0394183 A1
(43) Pub. Date: Dec. 7, 2023

(54) BEADING DESIGN TOOL METHODS AND SYSTEMS

(71) Applicant: GM GLOBAL TECHNOLOGY OPERATIONS LLC, Detroit, MI (US)

(72) Inventors: Lu Huang, Troy, MI (US); Nathan Sigmund, Macomb, MI (US); Hui-ping Wang, Troy, MI (US); Joshua Lee Solomon, Berkley, MI (US); Vivian Vasquez, St. Clair Shores, MI (US); Kris A Parker, Metamora, MI (US)

(73) Assignee: GM GLOBAL TECHNOLOGY OPERATIONS LLC, Detroit, MI (US)

(21) Appl. No.: 17/805,327

(22) Filed: Jun. 3, 2022

(51) Int. Cl. G06F 30/12; B21D 37/20

(52) U.S. Cl. CPC G06F 30/12; B21D 37/20; G06F 2111/10

(57) ABSTRACT

In accordance with various embodiments, methods and systems are provided for designing a bead tool and a bead for sheet metal forming. In one embodiment, a method includes: storing, in a datastore, a library of bead tool data associated with a plurality of bead tools; receiving, by a processor, a plurality of parameters associated with at least one of a punch and a die of a desired bead tool; computing, by the processor, bead tool data for at least one of the punch and the die of the desired bead tool based on the plurality of parameters; providing, by the processor, a subset of bead tool data from the library of bead tool data; receiving, by the processor, a selection of bead tool data from the subset of bead tool data and the computed bead tool data; and generating, by the processor, bead geometry data based on the selection and the bead tool data associated with the selection.

### INTRODUCTION

The technical field generally relates to the field of manufacturing system design and implementation, more specifically, to methods and systems for bead tool design and bead geometry calculations.

Manufacturing systems may be utilized for manufacturing vehicles, equipment, processes, devices, and/or other applications. Manufacturing systems utilize sheet metal to produce one or more body panels of a vehicle. Beads may be designed into the sheet metal in order to stiffen the sheet metal. Bead tools, including a punch and a die, are used to create the beads in the sheet metal. The bead tool varies depending on a size and a shape of the desired bead.

Accordingly, it is desirable to provide methods and systems for providing bead tool design and bead geometry calculations. Furthermore, other desirable features and characteristics of the present invention will become apparent from the subsequent detailed description of the invention and the appended claims, taken in conjunction with the accompanying drawings and this background of the invention.

### SUMMARY

In accordance with various embodiments, methods and systems are provided for designing a bead tool and a bead for vehicle manufacturing. In one embodiment, a method includes: storing, in a datastore, a library of bead tool data associated with a plurality of bead tools; receiving, by a processor, a plurality of parameters associated with at least one of a punch and a die of a desired bead tool; computing, by the processor, bead tool data for at least one of the punch and the die of the desired bead tool based on the plurality of parameters; providing, by the processor, a subset of bead tool data from the library of bead tool data; receiving, by the processor, a selection of bead tool data from the subset of bead tool data and the computed bead tool data; and generating, by the processor, bead geometry data based on the selection and the bead tool data associated with the selection.

In various embodiments, the plurality of parameters include at least one of a punch radius, a punch height, a punch side wall angle, a punch bottom fillet radius, a punch length, a punch tail length, a punch tail radius, and a punch tail bottom fillet radius.

In various embodiments, the plurality of parameters include at least one of a die fillet radius, a die opening width, a die depth, and a die inner fillet radius.

In various embodiments, the library of bead tool data is stored based on material and thickness.

In various embodiments, the library of bead tool data comprises, for each bead tool, a nominal thickness, a punch radius, a punch side radius, a bead fillet radius, a die fillet radius, a die depth, and a thickness.

In various embodiments, the bead geometry data includes at least one of a bead depth, a bead radius, and a bead fillet radius.

In various embodiments, the bead geometry data includes at least one of sheet top segment conforming to punch top data, sheet bottom segment conforming to punch top data, sheet top segment conforming to die fillet data, sheet bottom segment conforming to die fillet data, flat sheet top surface segment data, and flat sheet bottom segment surface data.

In various embodiments, the method includes generating visualization output data based on the computed bead tool data, wherein the visualization output data includes at least one of an object file and a mesh file.

In various embodiments, the computing of the bead geometry data is based on at least one of lines, arcs, surfaces, and relative positions of the at least one of lines, arcs, and surfaces.

In various embodiments, at least one of the receiving the plurality of parameters and the receiving the selection is based on user input generated based on a user interacting with a user interface.

In another embodiment, a system includes: a non-transitory computer readable medium that stores a library of bead tool data associated with a plurality of bead tools; a processor coupled to the non-transitory computer readable medium and configured to: receive a plurality of parameters associated with at least one of a punch and a die of a desired bead tool; compute bead tool data for at least one of the punch and the die of the desired bead tool based on the plurality of parameters; provide a subset of bead tool data from the library of bead tool data; receive a selection of bead tool data from the subset of bead tool data and the computed bead tool data; and generate bead geometry data based on the selection and the bead tool data associated with the selection.

In various embodiments, the plurality of parameters of the system include at least one of a punch radius, a punch height, a punch side wall angle, and a punch bottom fillet radius, a punch length, a punch tail length, a punch tail radius, and a punch tail bottom fillet radius.

In various embodiments, the plurality of parameters of the system include at least one of a die fillet radius, a die opening width, a die depth, and a die inner fillet radius.

In various embodiments, the library of bead tool data of the system is stored based on material and thickness.

In various embodiments, the library of bead tool data of the system comprises, for each bead tool, a nominal thickness, a punch radius, a punch side radius, a bead fillet radius, a die fillet radius, a die depth, and a thickness.

In various embodiments, the bead geometry data in the system includes at least one of a bead depth, a bead radius, and a bead fillet radius.

In various embodiments, the bead geometry data in the system includes at least one of sheet top segment conforming to punch top data, sheet bottom segment conforming to punch top data, sheet top segment conforming to die fillet data, sheet bottom segment conforming to die fillet data, flat sheet top surface segment data, and flat sheet bottom segment surface data.

In various embodiments, the processor of the system is further configured to generate visualization output data based on the computed bead tool data, wherein the visualization output data includes at least one of an object file and a mesh file.

In various embodiments, the processor if configured to compute the bead tool data based on at least one of lines, arcs, surfaces, and relative positions of the at least one of lines, arcs, and surfaces.

In various embodiments, the processor is configured to receive at least one of the plurality of parameters the selection based on user input generated based on a user interacting with a user interface.

### DESCRIPTION OF THE DRAWINGS

The present disclosure will hereinafter be described in conjunction with the following drawing figures, wherein like numerals denote like elements, and wherein:

FIG. 1 is a functional block diagram of a computer system for use in bead design and bead tool design for manufacturing, in accordance with various embodiments;

FIG. 2 is a dataflow diagram of a design system that may be incorporated into the computer system of FIG. 1, in accordance with various embodiments;

FIG. 3 is an illustration of parameters associated with a bead design tool, in accordance with various embodiments;

FIG. 4 is an illustration of visualization data that is generated by the bead design system, in accordance with various embodiments;

FIG. 5 is an illustration of parameters associated with a bead generated by the design system, in accordance with various embodiments; and

FIG. 6 is a flowchart of a process for designing a bead tool and/or a bead that can be implemented in connection with the design system of FIGS. 1 and 2, in accordance with various embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

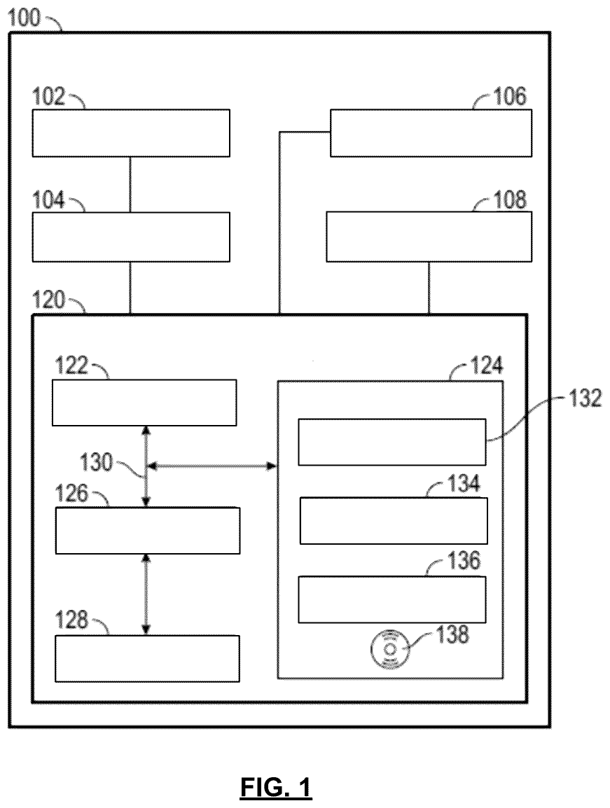

FIG. 1 is a functional block diagram of a design system (also referred to herein as the “system”) 100 for use in bead manufacturing, in accordance with various embodiments. The system 100 may be utilized in designing bead tools whereby the tools are used in manufacturing the bead. The system 100 may be further utilized in designing values relating to the geometry of the bead.

With reference to FIG. 1, in various embodiments the design system 100 includes an input device 102, input sensors 104, a display 106, and a computer system 120. Also as depicted in FIG. 1, in certain embodiments the design system 100 includes one or more transceivers 108 and/or other devices and/or components.

In various embodiments, the user input device 102 is configured to be utilized by one or more users involved in the design of beads. Also in various embodiments, the user input device 102 allows the user the opportunity to select different parameters. For example, as described in greater detail further below in connection with FIGS. 2-6, in various embodiments the user input device 102 collects user inputs as to parameters associated with a punch and a die of a desired bead tool and to a selection of a final design of a bead tool.

In various embodiments, the user input device 102 may comprise any number of different types of devices and/or combinations thereof. For example, in certain embodiments, the input device 102 may comprise one or more touch screens, keyboards, computer mice, joysticks, buttons, knobs, dials, microphones, and/or any number of other different types of input devices and/or combinations thereof. Also in various embodiments, the input sensors 104 are coupled to and/or integrated with the input device 102. In various embodiments, the input sensors 104 detect, measure, and/or record inputs provided by the user via the input device 102.

In various embodiments, the display 106 provides a display and/or other notification to the user as to the design of the bead tool and/or the geometry values associated with a bead. In various embodiments, the display 106 may include one or more display screens and/or other displays that provide a visual display for the user. Also in certain embodiments, the display 106 may comprise one or more speakers that provide an audio notification for the user. In certain embodiments, the display 106 may comprise one or more actuators and/or other devices that provide haptic and/or other notifications for the user. In certain embodiments, the display 106 may be part of and/or coupled with the input device 102 and/or the input sensors 104; however, this may vary in other embodiments.

As noted above, in certain embodiments, the system 100 may also include a transceiver 108. In certain embodiments, the transceiver 108 (and/or a receiver thereof) may receive user inputs and/or other data used for design. In addition, in certain embodiments, the transceiver 108 (and/or a transmitter thereof) may also be utilized in providing notifications to the user (e.g., as to the results of the determinations of the computer system 120).

As depicted in FIG. 1, in various embodiments, the computer system 120 comprises a processor 122, a memory 124, an interface, a storage device 128, a bus 130, and a disk 138. In certain embodiments, the computer system 120 may also include the user input device 102, input sensors 104, display 106, transceiver 108, and/or one or more other systems and/or components thereof. In addition, it will be appreciated that the computer system 120 may otherwise differ from the embodiment depicted in FIG. 1. For example, the computer system 120 may be coupled to or may otherwise utilize one or more remote computer systems and/or other control systems.

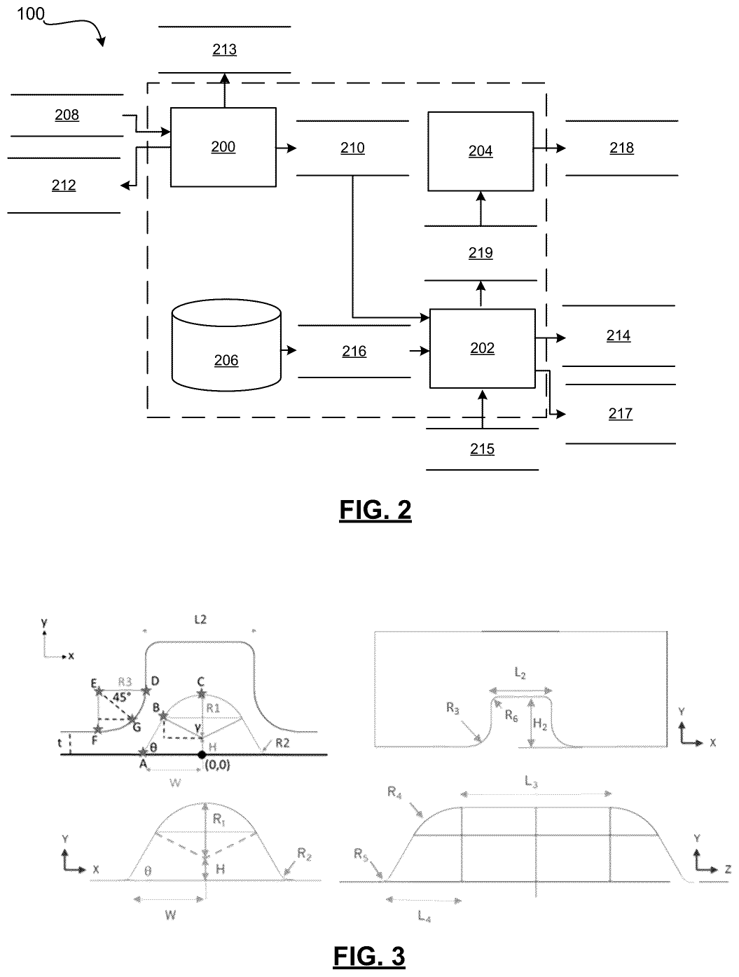

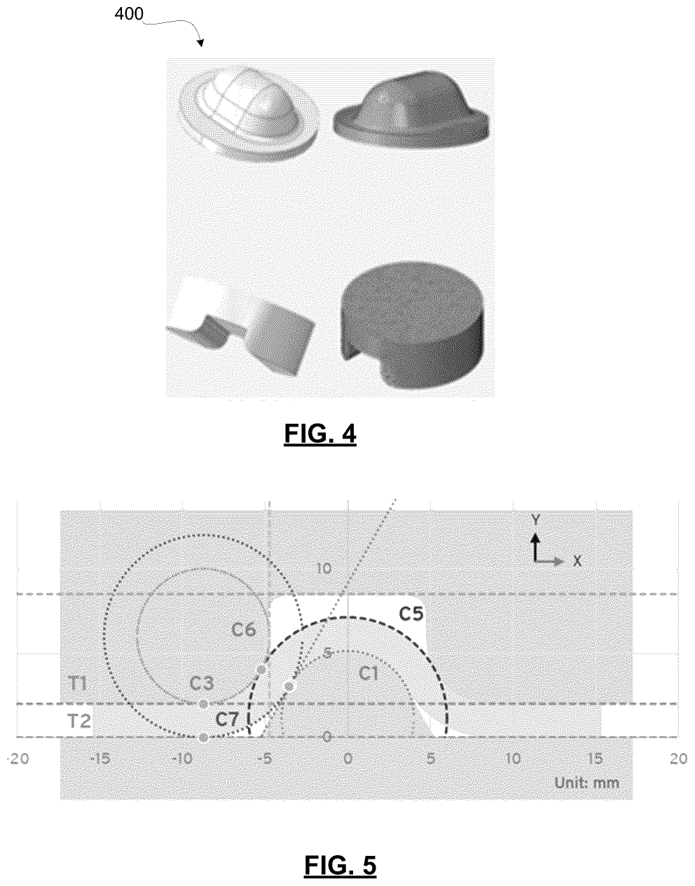

In the depicted embodiment, the computer system 120 includes a processor 122, a memory 124, an interface 126, a storage device 128, and a bus 130. The processor 122 performs the computation and control functions of the computer system 120, and may comprise any type of processor or multiple processors, single integrated circuits such as a microprocessor, or any suitable number of integrated circuit devices and/or circuit boards working in cooperation to accomplish the functions of a processing unit. During operation, the processor 122 executes one or more programs 132 contained within the memory 124 and, as such, controls the general operation of the computer system 120, generally in executing the processes described herein, such as the processes 600 discussed further below in connection with FIGS. 3 and 4.

The memory 124 can be any type of suitable memory. For example, the memory 124 may include various types of dynamic random access memory (DRAM) such as SDRAM, the various types of static RAM (SRAM), and the various types of non-volatile memory (PROM, EPROM, and flash). In certain examples, the memory 124 is located on and/or co-located on the same computer chip as the processor 122. In the depicted embodiment, the memory 124 stores the above-referenced program 132 along with a plurality of algorithms 134 and stored values 136 (e.g., including, in various embodiments, tables for implementing the process 600 of FIGS. 2-5).

The bus 130 serves to transmit programs, data, status and other information or signals between the various components of the computer system 120. The interface 126 allows communications to the computer system 120, for example from a system driver and/or another computer system, and can be implemented using any suitable method and apparatus. In one embodiment, the interface 126 obtains the various data from the user input device 102, input sensors 104, display 106, transceiver 108, and/or one or more other components and/or systems. The interface 126 can include one or more network interfaces to communicate with other systems or components. The interface 126 may also include one or more network interfaces to communicate with technicians, and/or one or more storage interfaces to connect to storage apparatuses, such as the storage device 128.

The storage device 128 can be any suitable type of storage apparatus, including various different types of direct access storage and/or other memory devices. In one exemplary embodiment, the storage device 128 comprises a program product from which memory 124 can receive a program 132 that executes one or more embodiments of one or more processes of the present disclosure, such as the steps of the processes 600 discussed further below in connection with FIGS. 3 and 4. In another exemplary embodiment, the program product may be directly stored in and/or otherwise accessed by the memory 124 and/or one or more other disks 146 and/or other memory devices.

The bus 130 can be any suitable physical or logical means of connecting computer systems and components. This includes, but is not limited to, direct hard-wired connections, fiber optics, infrared, and wireless bus technologies. During operation, the program 132 is stored in the memory 124 and executed by the processor 122.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 122) to perform and execute the program. Such a program product may take a variety of forms, and the present disclosure applies equally regardless of the particular type of computer-readable signal bearing media used to carry out the distribution. Examples of signal bearing media include recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system 120 may also otherwise differ from the embodiment depicted in FIG. 1, for example in that the computer system 120 may be coupled to or may otherwise utilize one or more remote computer systems and/or other control systems.

With reference to FIG. 2 and with continued reference to FIG. 1, a dataflow diagram illustrates elements of the design system 100 of FIG. 1 in accordance with various embodiments. As can be appreciated, various embodiments of the design system 100 according to the present disclosure may include any number of modules embedded within the memory 124 of the computer system 120 which may be combined and/or further partitioned to similarly implement systems and methods described herein. Furthermore, inputs to the design system 100 may be received from the user input device 102, the input sensors 104, the transceiver 108, other modules (not shown), and/or determined/modeled by other sub-modules (not shown). In various embodiments, the design system 100 includes a design and visualization module 200, a tool guidance module 202, a bead geometry module 204, and a tool data datastore 206.

In various embodiments, the design and visualization module 200 receives as input various user input data 208 and provides tool geometry data 210 and visualization output data 212. The user input data 208 can be received based on a user interacting with a user interface generated based on user interface data 213 configured to request tool parameters. For example, as shown in FIG. 4, the user input data 208 can include, but is not limited to, punch values such as a punch radius R1, punch height R1+H1, punch side wall angle θ, and punch bottom fillet radius R2, punch length L3, punch tail length L4, punch tail radius R5, punch tail fillet radius R6, and die values such as die fillet radius R3, die opening width L2, die depth H2, die inner filling radius R6, and a nominal thickness t. As can be appreciated, more or fewer values can be provided to simplify or improve the design such as, but not limited to bead width W, bead depth D, and/or width to depth ratio W/D may be input, in various embodiments.

With reference back to FIG. 2, the design and visualization module 200 processes the user input data 208 to produce tool geometry values. For example, twelve independent variables are used to parameterize the geometries of beading punches and dies of various tool configurations based on mathematical models using geometric elements such as arcs, straight lines, surfaces, and their relevant positions. As can be appreciated, more or fewer variables may be used to parameterize the geometries in various embodiments. The design and visualization module 200 generates the tool geometry data 210 that includes the tool geometry values.

In various embodiments, the design and visualization module 200 generates the visualization output data 212 to provide a visualization of a design tool having the determined tool geometry values. For example, as shown in FIG. 3 two dimensional or three-dimensional object files and/or mesh files 400 of the punch and die can be generated and displayed for use in further experimental or virtual analysis. In various embodiments, the files 400 are generated using defined mathematical models and rendering techniques.

With reference back to FIG. 2, the tool guidance module 202 receives as input the tool geometry data 210 and provides tool guidance data 214 based thereon. The tool guidance data 214 provides guidance on available tooling to ensure design for manufacturability and may be displayed to a user via a user interface. For example, the tool guidance module 202 generates the tool guidance data based on a comparison of similarity between the tool geometry data 210 and the library data 216 obtained from a library of available tools. The library is stored in the tool data datastore 206 based on, for example, materials and thicknesses. An exemplary entry in the library for an example tool can be displayed according to Table 1.

TABLE 1

| Tool Name | 2 × 4 | 3 × 6 | 4 × 8 |
|---|---|---|---|
| Nominal Thickness (mm) | 1 | 1.5 | 2 |
| Punch Radius, R(mm) | 2 | 3 | 4 |
| Punch Side Radius, Rs (mm) | 1.4 | 2 | 2.5 |
| Die Radius, Rd (mm) | 2.8 | 4.2 | 5.5 |
| Die Fillet Radius, r (mm) | 0.5 | 0.6 | 0.79 |
| Die Depth, h (mm) | 2.36 | 3.6 | 5.16 |

A user selects via user input data 215 by interacting with user interface data 217, or optionally the tool guidance module 202 selects based on a determined similarity, a tool from the library and/or the designed tool and generates selected tool data 219.

The bead geometry module 204 receives as input the selected tool data 219 and generates bead geometry data 218 including characteristic parameters of bead geometries based on the selected tooling. In various embodiments, the bead geometry data 218 can include a bead depth D, a bead radius R, and a bead fillet radius r and is generated to a user by text or graphics for further analysis. In various embodiments, the bead geometries are calculated and constructed by assuming that the sheet metal conforms to the tools where possible, yielding bead dimension outputs as key geometric input parameters for the design system 100.

In various embodiments, with reference to FIGS. 3 and 5, the bead geometry module 204 uses the relationships of beading tool profiles shown in Table 2 and computes the geometry values based on the expressions in Table 3. The bead geometry module 204 generates the bead geometry data 218 based on the computed values.

TABLE 2

| | | |
|---|---|---|
| Punch Top | C1: x² + (y − y₁) = R₁² | Where y₁ = H |
| Punch Side | L1: y = kc + c₁ | Where |
| | | k = tan 0 |
| | | c₁ = (R₁/cos θ) + H |
| Punch Bottom | C2: (x − x₂)² + (y − y₂)² = R₂² | Where |
| Fillet | | x₂ = −(r+ c₁)/tanθ |
| | | y₂ = R₂ |
| Die Fillet | C3: (x − x₃)² + (y − y₃)² = R₃² | Where |
| | | ${x}_{4} = \frac{L 2}{2} - {R}_{3}$ |
| | | y₄ = t + R₃ |
| Die Radius | C4: (x − x₄)² + (y − y₄)² = R₄² | Where |
| | | ${x}_{3} = - \frac{L 2}{2} + {R}_{4}$ |
| | | y₃ = d + t −R₄ |
| Die Side Wall | L2: x = c₂ | Where |
| | | ${c}_{2} = - \frac{L 2}{2}$ |
| Die Top | L3: y = c₃ | Where |
| | | c₃ = d + t |

TABLE 3

| | |
|---|---|
| Sheet top to punch top | C5: x² + (y − y₁)² = (R + t)² |
| Sheet bottom to punch top | C1 |
| Sheet top to die fillet | C6: (x − x₃)² + (y − y₃)² = R₅² |
| Sheet bottom to die fillet | C7: (x − x₃)² + (y − y₃)₂ = R₆² |
| Sheet top surface | T1: y = t |
| Sheet bottom surface | T2: y = 0 |

In various embodiments, R₅ and R₆ are dependent variables that are determined based on tangent relationships where C5 is tangent to C3 and C4 and C6 is tangent to T2 and L1 or Cl. The independent geometry variables can include sheet thickness (t), punch radius R₁, punch height R₁+H, punch side wall angle Θ, punch bottom fillet radius R₂, die fillet radius R₃, die opening width L₂, and die depth d.

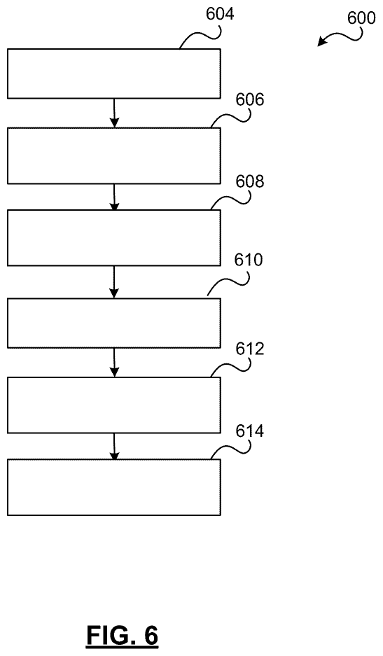

With reference now to FIG. 6, a flowchart of a process 600 for designing a bead tool and/or beading is shown in accordance with various embodiments. The process 600 can be implemented in connection with the system 100 of FIG. 1. The process 600 is described in detail in connection with FIG. 2 as well as in connection with FIGS. 3-5, which depict illustrative steps of the process 600 in accordance with various embodiments.

As explained in greater detail below, in various embodiments, the process 600 provides analysis of bead tools and bead geometries. As depicted in FIG. 6, in various embodiments the process 600 begins at 602. In certain embodiments, the process 600 begins when a user calls for the process 600 to begin operation, for example as the design of the bead tool or bead is begun.

In various embodiments, user input data 208 is received indicating user input parameters at 604. For example, the user inputs various punch and die parameters (e.g., twelve or more as discussed above) by interacting with a user interface generated by the user interface data 213 and via the user input device 102 and/or one or more of the input sensors 104. The tool geometry data 210 is computed based on the user input data 208 at 606 and the object and/or mesh files 400 are included in the visualization output data 212 generated to display the tool geometry via the display 106 at 608.

Thereafter, user input data 215 is received to select a tool from the library data 216 and/or the tool geometry data 210 at 610. For example, the user inputs a selection by interacting with a user interface generated by the user interface data 217 and via the user input device 102 or one or more of the input sensors 104.

Thereafter, the bead geometry data 218 is computed based on the selected tool data 219 and the relationships discussed above at 612 and provided to the user via the bead geometry data 218 to display the tool geometry via the display 106 at 614. As can be appreciated, the process 600 may continue until the user is satisfied with the design of the bead tool and or the bead itself.

It will be appreciated that the methods and systems may vary from those depicted in the Figures and described herein. For example, in various embodiments, the design system 100 and/or other components may differ from those depicted in FIGS. 1 and 2 and/or described above in connection therewith. It will also be appreciated that the steps of the process 600 may differ, and/or that various steps thereof may be performed simultaneously and/or in a different order, than those depicted and/or described above.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. A method for designing a bead tool and a bead, the method comprising:
storing, in a datastore, a library of bead tool data associated with a plurality of bead tools;
receiving, by a processor, a plurality of parameters associated with at least one of a punch and a die of a desired bead tool;
computing, by the processor, bead tool data for at least one of the punch and the die of the desired bead tool based on the plurality of parameters;
providing, by the processor, a subset of bead tool data from the library of bead tool data;
receiving, by the processor, a selection of bead tool data from the subset of bead tool data and the computed bead tool data; and
generating, by the processor, bead geometry data based on the selection and the bead tool data associated with the selection.

2. The method of claim 1, wherein the plurality of parameters include at least one of a punch radius, a punch height, a punch side wall angle, a punch bottom fillet radius, a punch length, a punch tail length, a punch tail radius, and a punch tail bottom fillet radius.

3. The method of claim 2, wherein the plurality of parameters include at least one of a die fillet radius, a die opening width, a die depth, and a die inner fillet radius.

4. The method of claim 1, wherein the library of bead tool data is stored based on material and thickness.

5. The method of claim 4, wherein the library of bead tool data comprises, for each bead tool, at least one of and not limited to a nominal thickness, a punch radius, a punch side radius, a bead fillet radius, a die fillet radius, and a die depth.

6. The method of claim 1, wherein the bead geometry data includes at least one of a bead depth, a bead radius, and a bead fillet radius.

7. The method of claim 1, wherein the bead geometry data includes at least one of sheet top segment conforming to punch top data, sheet bottom segment conforming to punch top data, sheet top segment conforming to die fillet data, sheet bottom segment conforming to die fillet data, flat sheet top surface segment data, and flat sheet bottom segment surface data.

8. The method of claim 1, further comprising generating visualization output data based on the computed bead tool data, wherein the visualization output data includes at least one of an object file and a mesh file.

9. The method of claim 1, wherein the computing the bead tool data is based on at least one of lines, arcs, surfaces, and relative positions of the at least one of lines, arcs, and surfaces.

10. The method of claim 1, wherein at least one of the receiving the plurality of parameters and the receiving the selection is based on user input generated based on a user interacting with a user interface.

11. A system for designing a manufacturing system, the system comprising:
a non-transitory computer readable medium that stores a library of bead tool data associated with a plurality of bead tools;
a processor coupled to the non-transitory computer readable medium and configured to:
receive a plurality of parameters associated with at least one of a punch and a die of a desired bead tool;
compute bead tool data for at least one of the punch and the die of the desired bead tool based on the plurality of parameters;
provide a subset of bead tool data from the library of bead tool data;
receive a selection of bead tool data from the subset of bead tool data and the computed bead tool data; and
generate bead geometry data based on the selection and the bead tool data associated with the selection.

12. The system of claim 11, wherein the plurality of parameters include at least one of a punch radius, a punch height, a punch side wall angle, a punch bottom fillet radius, a punch length, a punch tail length, a punch tail radius, and a punch tail bottom fillet radius.

13. The system of claim 12, wherein the plurality of parameters include at least one of a die fillet radius, and a die opening width.

14. The system of claim 11, wherein the library of bead tool data is stored based on material and thickness.

15. The system of claim 14, wherein the library of bead tool data comprises, for each bead tool, a nominal thickness, a punch radius, a punch side radius, a bead fillet radius, a die fillet radius, and a die depth,

16. The system of claim 11, wherein the bead geometry data includes at least one of a bead depth, a bead radius, and a bead fillet radius.

17. The system of claim 11, wherein the bead geometry data includes at least one of sheet top segment conforming to punch top data, sheet bottom segment conforming to punch top data, sheet top segment conforming to die fillet data, sheet bottom segment conforming to die fillet data, flat sheet top surface segment data, and flat sheet bottom segment surface data.

18. The system of claim 11, wherein the processor is further configured to generate visualization output data based on the computed bead tool data, wherein the visualization output data includes at least one of an object file and a mesh file.

19. The system of claim 11, wherein the processor if configured to compute the bead tool data based on at least one of lines, arcs, surfaces, and relative positions of the at least one of lines, arcs, and surfaces.

20. The system of claim 11, wherein the processor is configured to receive at least one of the plurality of parameters the selection based on user input generated based on a user interacting with a user interface.
